(19) United States
(12) Patent Application Publication
(10) Pub. No.: US 2009/0262072 A1
(43) Pub. Date: Oct. 22, 2009

(54) Cursor control system and method thereof

(75) Inventor: Stephen Chen, Changhua (TW)

Correspondence Address: ROGER H. CHU, 19499 ERIC DRIVE, SARATOGA, CA, 95070, US

(73) Assignee: E-LEAD ELECTRONIC CO., LTD., Shengang Shiang (TW)

(21) Appl. No.: 12/107,075

(22) Filed: Apr. 22, 2008

(51) Int. Cl. G06F 3/033

(52) U.S. Cl. 345/157

(57) ABSTRACT

A cursor control system and method thereof, provides two-staging cursor control procedures for the first stage, displaying a template dividing the screen into plural districts, and moving the cursor from the original location to the selected district, and for the second stage, moving the first cursor from the selected district to another location designated location.

### FIELD OF THE INVENTION

The present invention relates to a cursor control system and method thereof, especially a two-staging cursor control system and method thereof.

### BACKGROUND OF THE INVENTION

Generally, human-computer interaction is composed of character input device and directional control device; while the character input device generally includes keyboards or hand writing device, the directional control device is for controlling cursor movements. Such devices include mouses, joysticks, arrow keys, touch panels, touch-pads, etc. The aforementioned arrow keys and joystick control the direction of cursor movement easily, lack precise cursor speed control; consequently, such time-consuming operations have not been extensively applied in the field. In addition, it is more convenient for a user to use his/her finger on the edge of a mouse button to move the cursor around the screen; however, the mouse movements require a lot of space, so that such applications are not suitable for a small electronic device. Nowadays, touch pads have been widely applied in mobile notebook PC devices, due to the excellence in its small size and convenient operations than a joystick or arrow keys. The aforementioned cursor control methods all allow the cursor movement on the screen to be adjusted by a user's eyes based on the current location of the cursor on the screen. If the current location of the cursor is far away from an aimed target, it is a time-consuming process to move the cursor towards to the aimed item on the touch screen, it requires much longer time in moving arrow keys or a joystick to the aimed item, the mouse movement requires a bigger space for operations. Touch screens have been highly applied on various small electronic devices nowadays, but there are several disadvantages to using a finger or a touch pen. For example, the palm of hand usually hinders a user from screen views, and the finger touch easily stains the screen, etc.

One method to reduce the problem uses the speed of the user's finger on the touch-pad to determine the enlargement scale. When a user's finger moves quickly, the motion is aggressively scaled and the cursor moves faster, while slower movements are more delicately scaled to aim at a target on the screen. This method slightly reduces the above problem of using a device with a touch-pad; however, such a method is unable to satisfy most users.

A prior art of the U.S. Pat. No. 5,327,161 is mainly with a touchpad input device having a drag switch and touch device in which the direction of movement of the touch device across the touchpad surface is determined, a display cursor is caused to move in the same relative direction as the direction determined by the touch device, so as to allow the cursor to be moved a greater distance than the touch device (i.e. moved quicker and more sensitive). However, the U.S. Pat. No. 5,327,161 still has a practicable problem in leveling the cursor at an object on the screen due to sensitivity. Moreover, China Patent No. CN1940837 disclosed a method of fast cursor positioning, the invention positions the cursor on a location on the screen of a touch pad device corresponding to a position where a user's finger or a touch pen is contacted the device, but is unable to further position the cursor to a designated position.

In summary, how to remove the inconvenience of a user during the operation of the cursor movement is a true concern for practicability in the field.

### SUMMARY OF THE INVENTION

In view of the forgoing defects of conventional techniques, a cursor control system and method thereof, specially a two-staging cursor control system and method thereof, is disclosed hereafter, to facilitate the effect of fast cursor movement on the screen.

The main objective of the invention is to provide a two-staging cursor control method. During the first stage of cursor movement, a cell grid area (template) is displayed on the screen, dividing the screen into plural screen districts (areas). Subsequently, a user selects a screen district displayed on the screen and operates in the selected screen district; the process at the first stage of cursor movement is ended after the cursor is moved from the initial place to the position in the selected screen district. During the second stage of cursor control process, the user moves the cursor from the position in the selected screen district to another designated position to achieve the objective of quick cursor movement.

Another objective of the invention is to provide a two-staging cursor control system, at least comprising a display division module, a display selection unit, a display signal module, and a cursor control unit. The display division module is to display or hide the cell grid area on the screen. The display selection unit enables a user to select a screen district, and then, inputs an area signal representing the selected screen district. The display signal module detects an area signal, provides the location information of the area signal for further process, and sends the information to the cursor control unit. The cursor control unit directly moves the cursor in the selected screen district based on the location information of the area signal.

Another objective of the invention is to provide a two-staging cursor control method, which at least comprises the following steps of (1) displaying a template dividing a screen into plural screen districts; (2) detecting an area signal representing a selected screen district on the screen; (3) moving the cursor towards a first position within the selected screen district based on the area signal; and (4) moving the cursor from the first position within the selected screen district toward a second position.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flow chart showing a cursor control system and method of the invention;

FIGS. 2-1, 2-2, 2-3 and 2-4 are perspective views showing the first embodiment of the cursor control system of the invention;

FIGS. 3-1, 3-2 and 3-3 are perspective views showing the second embodiment of the cursor control system of the invention;

FIG. 4 is a flow chart showing the steps of the cursor control method of the invention; and

FIG. 5 is an illustrative view showing the third embodiment of the cursor control system of the invention.

### DETAILED DESCRIPTION OF THE INVENTION

The invention discloses a cursor control system and method thereof herein. The invention is a two-staging cursor control system and method thereof, enabling a user to apply the two-staging cursor control method to achieve the purpose of the quick cursor movement across the screen. To enable a further understanding of the structural features and the technical contents of the invention, the brief description of the steps and drawings is followed by the detailed description of embodiments.

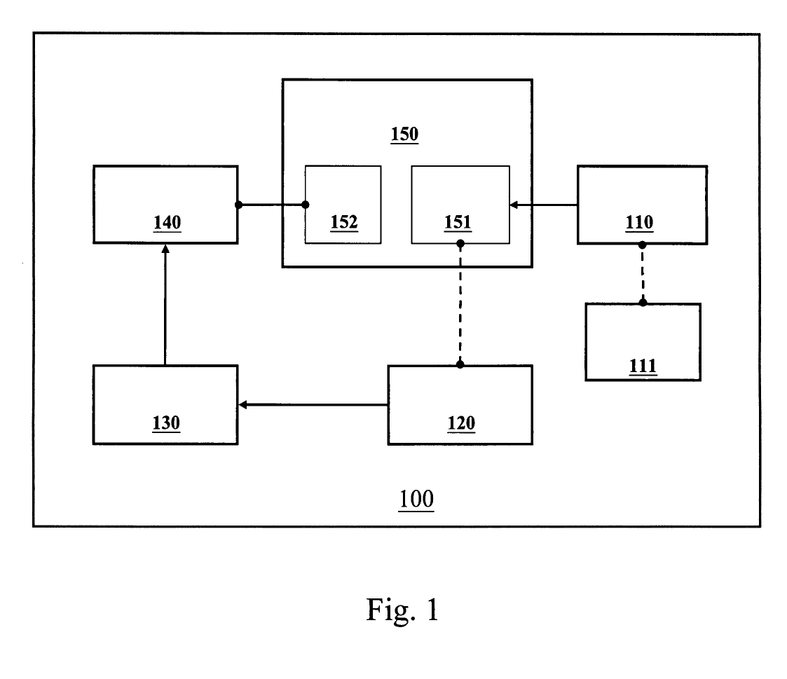

FIG. 1 is a flow chart showing a cursor control system and method of the invention. As shown on FIG. 1, a cursor control system 100 at least comprises a display division module 110, a display selection unit 120, a display signal module 130, and a cursor control unit 140. The display division module 110 enables a press button 111 to be pressed for displaying or hiding a cell grid area 151 on a screen 150 when the screen division function is activated, the press button 111 enables the cell grid area 151 to be displayed or hided on the screen 150. The cell grid area 151 is displayed the same size as the screen 150 and applied to divide the screen 150 into plural screen districts. The display selection unit 120 enables a user to select one of the plural screen districts on the screen 150 and an area signal representing the selected screen district to be inputted. The display signal module 130 detects the area signal representing the selected screen district that is entered through the display selection unit 120 based on the user's selection, calculates and sends the location information of the area signal to the cursor control unit 140. The cursor control unit 140 directly moves a cursor 152 on the screen 150 to the selected screen district, after the location of the area signal is calculated by the display signal module 130 and received. The method of moving the cursor 152 by the cursor control unit 140 includes either moving the cursor 152 on the screen 150 from the original position to a position on the selected screen district, or directly placing the cursor 152 on a position within the selected screen district. The cell grid area 151 is a translucent template with grid lines, coving the whole area of the screen 150 on the top; in addition, those divided screen districts appear to be the same size. The display selection unit 120 is set on a touch pad, which comprises multiple cells the same number as the plural screen districts divided by the grid lines on the screen.

FIGS. 2-1, 2-2, 2-3 and 2-4 are perspective views showing a first embodiment of the cursor control system of the invention.

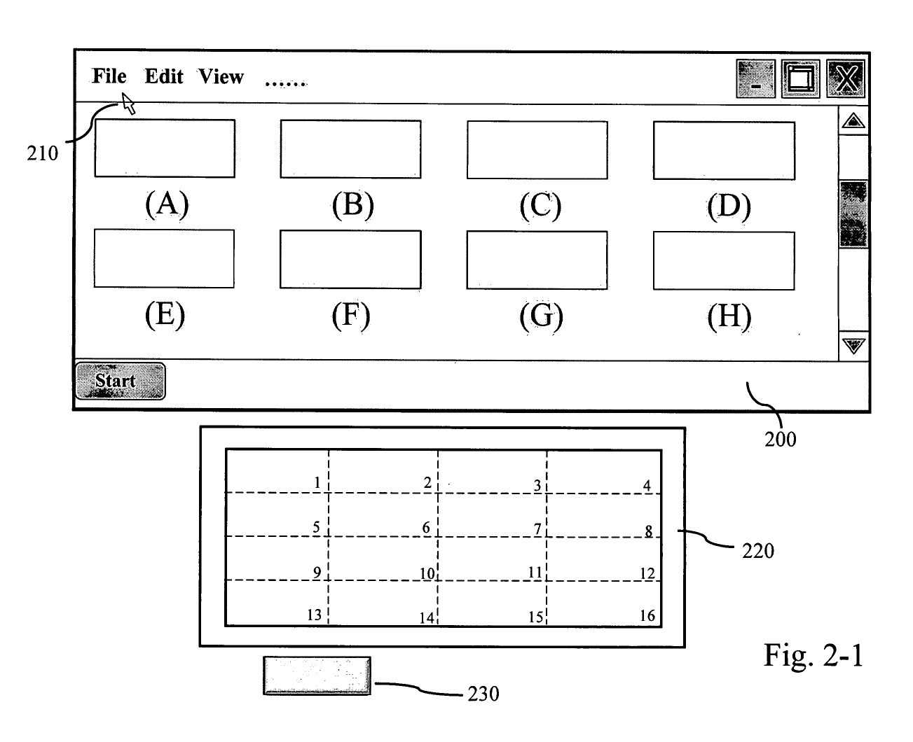

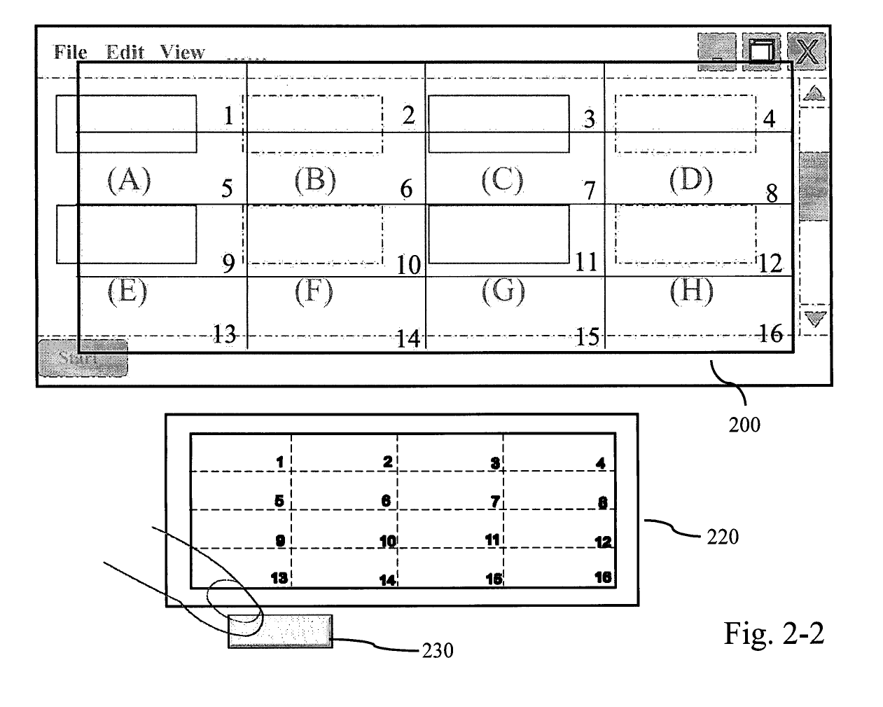

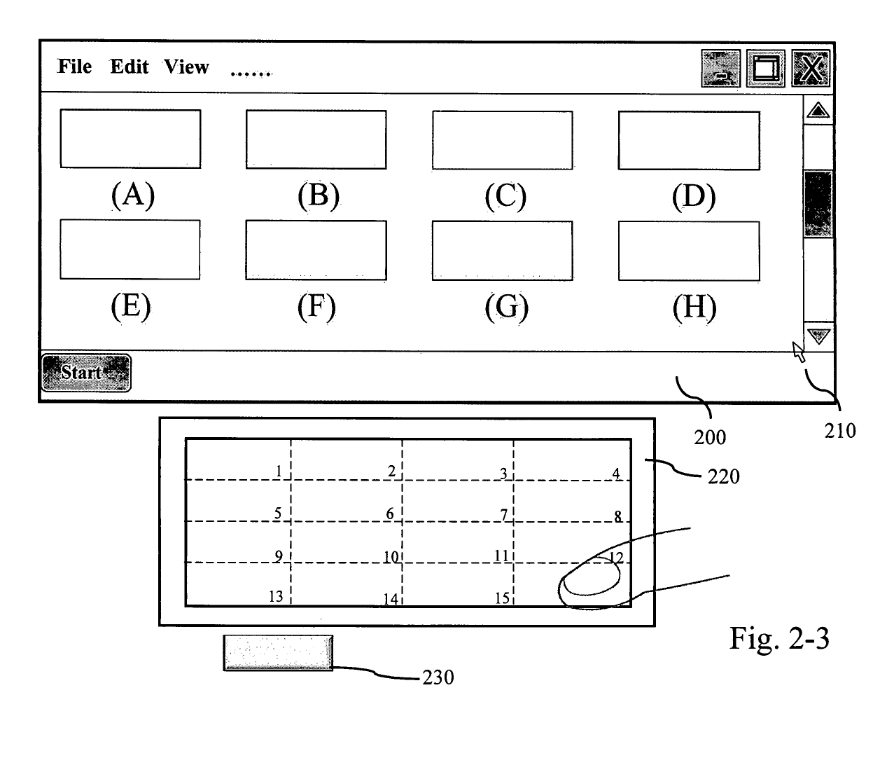

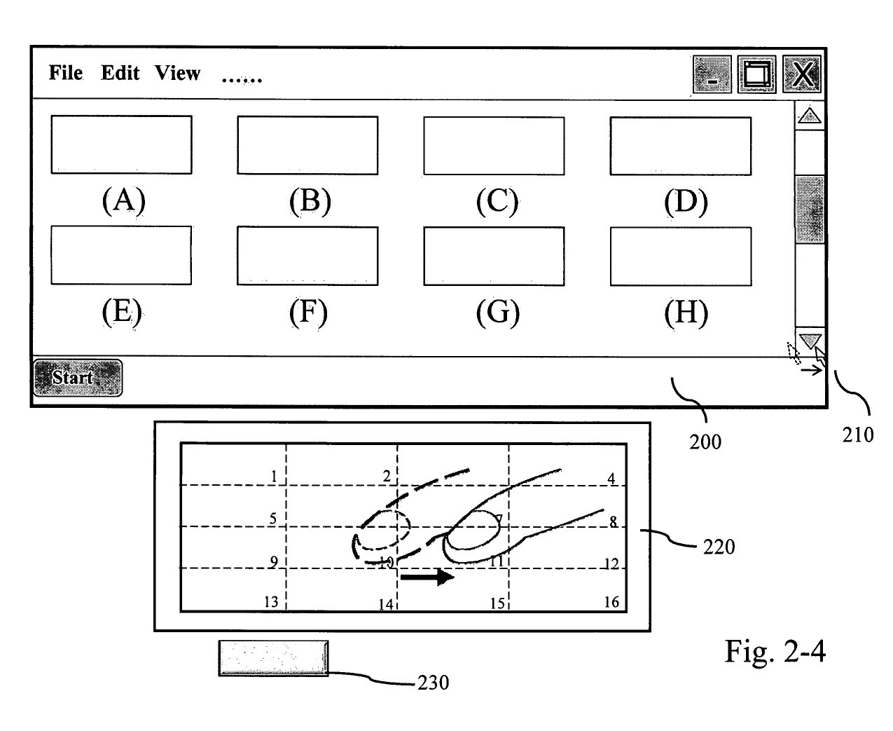

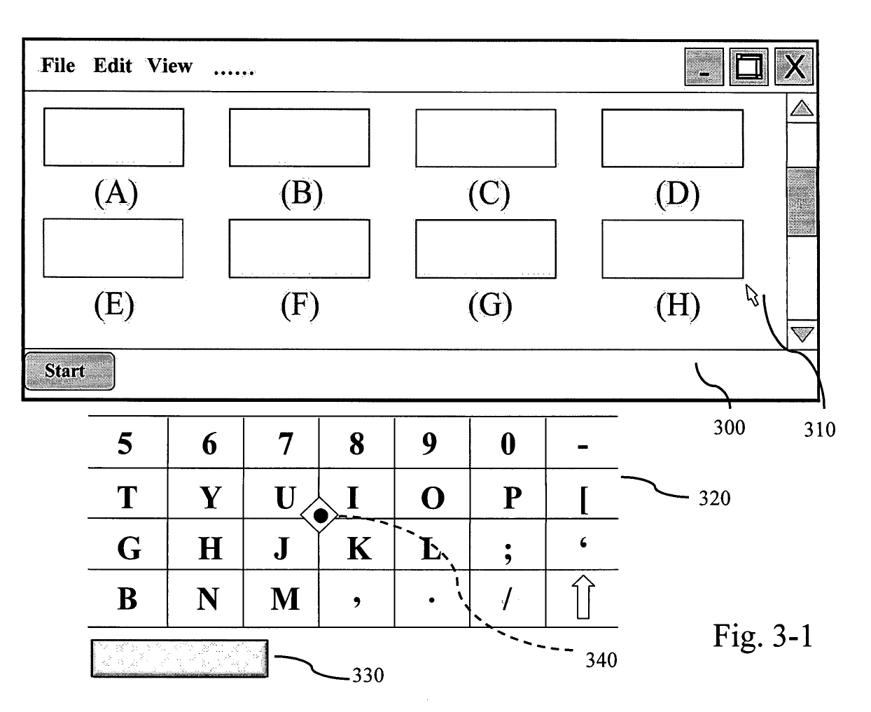

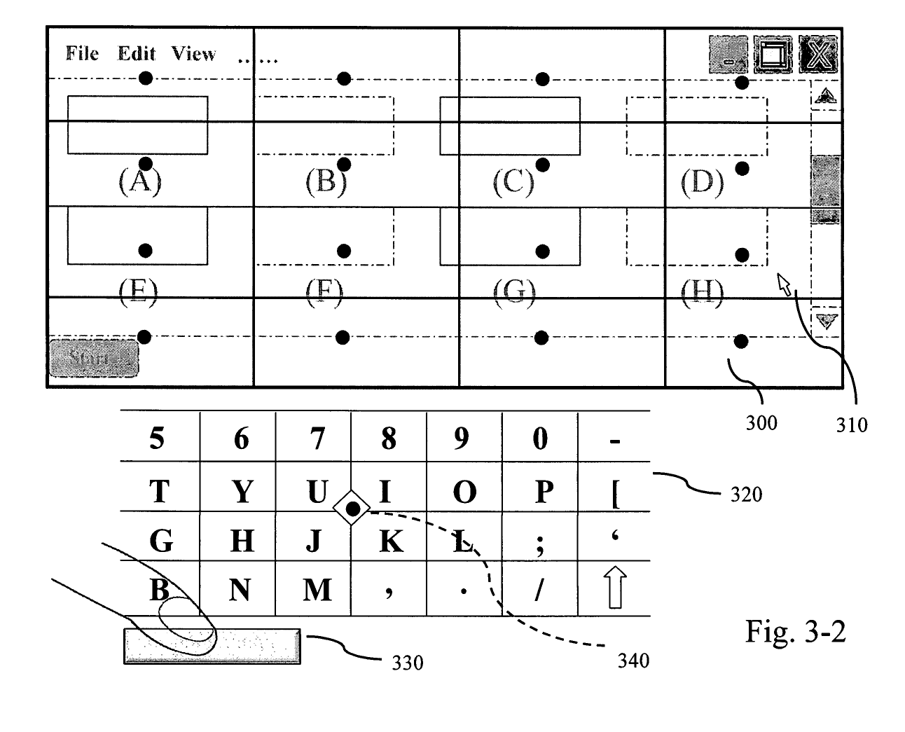

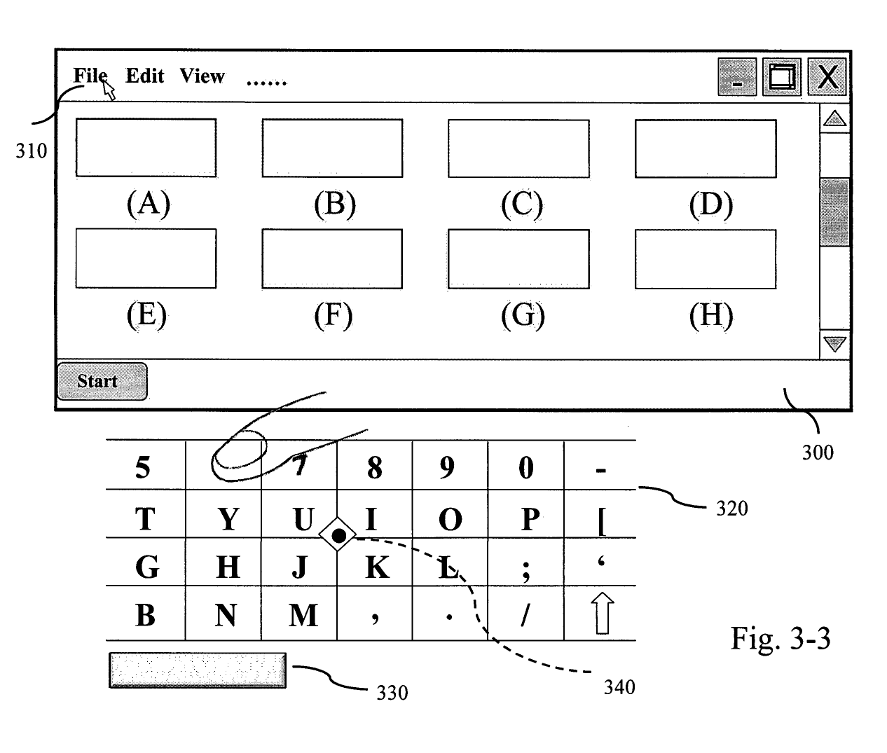

As the first embodiment shown in FIG. 2-1, a screen 200 is under normal operation and a cursor 210 is pointed at ‘File’; while a touch pad 220 comprises 16 rectangle cells, and a press button 230 is positioned below the touch pad 220 for a user to activate the division of the screen 200 into plural areas and enables the user to move the cursor 210 from the upper left corner to the lower right corner and scroll down the screen to select an item. With the reference to FIG. 2-2, the screen 200 is in the display division state when the user presses the press button 230 for activating the display division function; each divided screen district on the screen 200 is then correspondent with each rectangle cell on the touch pad 220, which displays a number from No. 1 to No. 16 the same as the number showed in its corresponding screen district. As the first embodiment shown in FIG. 2-3, the item to be selected is the screen district No. 16, the screen is scrolled down to display the screen district No. 16 when the user touches the rectangle cell No. 16 on the touch pad 220, thereby the cursor 210 is directly moved to the center of the screen district No. 16 on the screen 200 and the display division state of the screen 200 is then cancelled. As the first embodiment shown in FIG. 2-4, the cursor 210 is then moved near the item to be selected at roller bar, therefore, the user only needs to slightly move his/her finger around the touch pad 220 from any point to the right direction, the cursor 210 is moved to the item on the screen 200; the user is able to activate the screen scroll-down function by pressing the press button.

As the display selection unit 120 is set inside the touch pad 220, which comprises 16 rectangle cells on the touch pad 220 corresponding to plural screen districts that are divided by the cell grid area 151 with some symbols or numbers displayed on the rectangle cells (exampled as No. 1˜No. 16 in the embodiment), when the press button 230 (for activating display division) is pressed by the user, the display division module 110 enables a cell grid area 151 to be displayed on the screen 150 and further enables symbols or numbers referring to the screen districts each, so that a user easily refers those symbols or numbers displayed on the screen districts to select a screen district desired and an area signal representing the selected screen district is then inputted.

FIGS. 3-1, 3-2 and 3-3 are perspective views showing the second embodiment of the cursor control system of the invention.

As the second embodiment shown in FIG. 3-1, a screen 300 is under normal operation and a cursor 310 is pointed at the lower right corner on the screen 300, in addition, only a part of a keyboard 320 is shown in FIG. the drawing for example, while the keyboard 320 comprises a touch cap 340 for moving the cursor 310 and a press button 330 for activating area division is set below the keyboard 320 for dividing the screen 300 into plural districts. With reference to FIG. 3-2, when a user moves the cursor 310 to point at ‘File’ on the screen 300 and presses down the press button 330 for activating area division, thereby the screen 300 is divided into plural screen districts, which on the screen 300 are respectively corresponding to those buttons on the keyboard 320 each. In the second embodiment, the screen districts are mapped to a total of 16 buttons from Column No. 6˜9. As shown in FIG. 3-3, the location of ‘File’ on upper left of the screen is correspondent with button 6, when a user presses down button 6, the cursor 310 is directly moved to the center of the cell grid near the position on the lower right point of ‘File’, and then the display division on the screen 300 is disappeared (canceled), subsequently, when the user slightly moves his/her finger on a touch cap 340 towards the upper left direction, the cursor 310 on the screen 300 is moved to ‘File’ to enable the user to press the button for executing the function of ‘File’.

In view of the foregoing, the display selection unit 120 is set inside the keyboard 320 and plural buttons are positioned on the keyboard 320 corresponding to plural screen districts on the cell grid area 151 when a press button 330 (for activating area division) is pressed down, the display division module 110 enables the cell grid area 151 to be displayed on the screen 150, in addition, specific letters or symbols are displayed on the screen districts divided by the cell grid area 151, so that the user easily refers to those letters or symbols and select a screen district and enters an area signal representing the screen district for further operation.

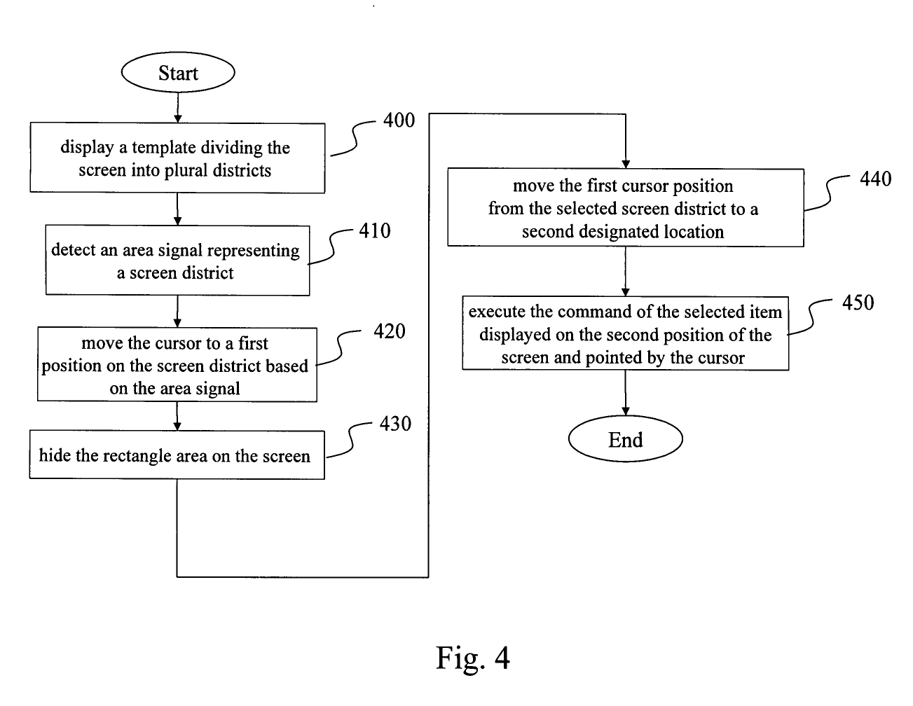

FIG. 4 is a flow chart showing the steps of the cursor control method of the invention. The cursor control method of the invention is a two-staging cursor control method enabling a cursor to be moved quickly on a screen. During the first stage of cursor movement as shown in FIG. 4, the display division module 110 enables the screen 150 to be divided into plural screen districts, and then, the cell grid area 151 is displayed on the screen 150 (Step 400). Subsequently, a user selects a screen district 151n displayed on the screen 150 and the display selection unit 120 receives an area signal representing the screen district. The next step is that the display signal module 130 detects the area signal representing the screen district 151n on the screen 150 (Step 410), and the display signal module 130 calculates and send the location information of the area signal to the cursor control unit 140. The cursor control unit 140 directly moves the cursor 152 to a first position within the screen district 151n, after the location of the area signal is received (Step 420). The movement of the cursor 152 in Step 420 comprises moving the original position of the cursor 152 to the first position on the screen 150, or directly placing the cursor 152 at the first position on the screen 150. After the cursor control unit 140 moves the cursor 152 to the first position within the screen district, the display division module 110 hides the cell grid area 151 on the screen 150 (Step 430). During the second stage cursor control process, the user operate general cursor movement to move the cursor 152 from the first position to a second position within the screen district (Step 440). Subsequently, the user clicks an item displayed on the screen 150 where the cursor 152 is on the second position (Step 450). The flow is then ended.

Consequently, a user is able to employ the two-staging cursor control method in the cursor control system in accordance with the invention to achieve the quick cursor movement on a display screen.

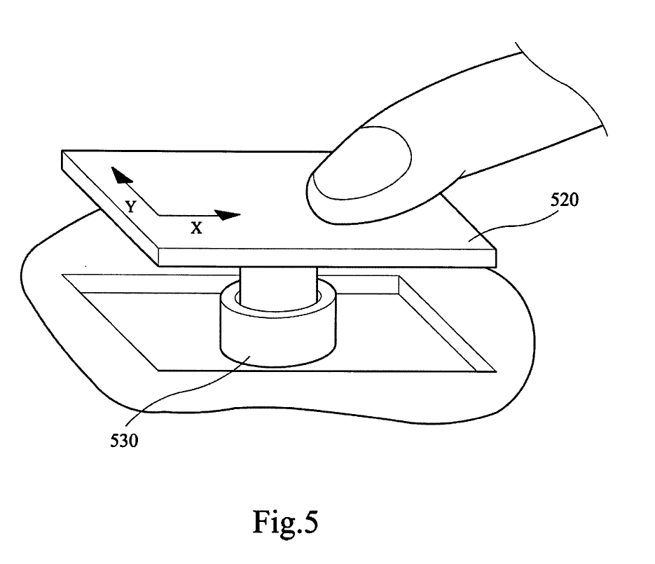

FIG. 5 is an illustrative view showing the third embodiment of the cursor control system of the invention. The difference between the third embodiment and the first embodiment lies in that the press button 230 in the first embodiment is replaced with a button touch pad 520 and a press component 530 for activating area division.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A cursor control system, at least comprising the following steps:
displaying a cell grid area dividing a screen into plural screen districts;
detecting an area signal representing a screen district on said screen;
moving a cursor to a first position on said screen district based on said area signal; and
moving the cursor from said first position to a second position within said selected screen district.

2. The cursor control method as claimed in claim 1, wherein said method further comprises a step of hiding said cell grid area on said screen.

3. The cursor control method as claimed in claim 1, wherein said method further comprises a step of executing a selected item where said cursor is pointed at on said screen.

4. The cursor control method as claimed in claim 1, wherein said cell grid area covers the whole scale of said screen.

5. The cursor control method as claimed in claim 1, wherein said cell grid area is a translucent template or cell grids cover the whole area of said screen on the top.

6. The cursor control method as claimed in claim 1, wherein said cell grid area divides said screen into plural screen districts of the same size.

7. The cursor control method as claimed in claim 1, wherein said first position is positioned on the center of said screen district.

8. The cursor control method as claimed in claim 1, wherein said area signal is entered through a display selection unit.

9. The cursor control method as claimed in claim 9, wherein said display selection unit is set inside a keyboard, which comprises plural buttons corresponding to said screen districts divided by said cell grid area.

10. The cursor control method as claimed in claim 9, wherein said method further comprises specific letters or symbols to represent said screen districts for display.

11. The cursor control method as claimed in claim 8, wherein said display selection unit is positioned in a touch pad, which comprises multiple cells the same number as said plural screen districts divided by said cell grid area.

12. The cursor control method as claimed in claim 11, wherein said method further comprises displaying correspondent symbols or letter in said screen districts each.

13. The cursor control method as claimed in claim 1, wherein said step of displaying a cell grid area dividing a screen into plural screen districts is activated when a user presses down a press button.

14. The cursor control method as claimed in claim 1, wherein said step of moving a cursor to a first position on said screen district based on said area signal is to move said cursor from the original position to said first position on said screen.

15. The cursor control method as claimed in claim 1, wherein said step of moving a cursor to a first position on said screen district is to directly move said cursor on said first position on said screen.

16. A cursor control system, at least comprising
a display division module, displaying or hiding a cell grid area on a screen, said cell grid area dividing said screen into plural screen districts;
a display selection unit, enabling an area signal representing said screen district to be entered
a display signal module, detecting said area signal entered through said display selection unit and processing the location information of said area signal; and
a cursor control unit, receiving the location of said area signal of said display signal module and directly moving said cursor to said screen district.

17. The cursor control system as claimed in claim 16, wherein said cell grid area covers the whole scale of said screen.

18. The cursor control system as claimed in claim 16, wherein said cell grid area is a translucent template the same size of the screen on the top.

19. The cursor control system as claimed in claim 16, wherein said cell grid area is applied to divide said screen into plural screen districts by grid lines.

20. The cursor control system as claimed in claim 16, wherein said cell grid area divide said into plural screen districts of the same size.

21. The cursor control system as claimed in claim 16, wherein said display selection unit is set inside a keyboard, which comprises multiple cells corresponding to said plural screen districts divided by said cell grid area.

22. The cursor control system as claimed in claim 21, wherein said display division module further comprises specific letters or symbols representing said screen districts each for display.

23. The cursor control system as claimed in claim 16, wherein said display selection unit is positioned in a touch pad to divide the cell grid area into plural screen areas.

24. The cursor control system as claimed in claim 23, wherein said display division module further display said letters or symbols of correspondent screen districts.

25. The cursor control system as claimed in claim 16, wherein said display division module activates the area division function to display or hide said cell grid area when a press button is pressed.

26. The cursor control system as claimed in claim 25, wherein said press button is provided on a button touch pad.
